(19) United States
(12) Patent Application Publication
(10) Pub. No.: US 2011/0117352 A1
(43) Pub. Date: May 19, 2011

(54) Self-primed fabric in self-reinforced polyethylene composites

(76) Inventors: Shalaby W. Shalaby, Anderson, SC (US); Shawn Peniston, Easley, SC (US)

(21) Appl. No.: 12/925,741

(22) Filed: Oct. 28, 2010

Related U.S. Application Data
(60) Provisional application No. 61/279,932, filed on Oct. 28, 2009.

(51) Int. Cl. B32B 5/02

(52) U.S. Cl. 428/221

(57) ABSTRACT

A self-reinforced polyethylene composite includes a self-primed fabric reinforcement, such as a warp-knitted mesh, and has a fabric/matrix weight ratio of 10/90 to 45/55. Prior to inclusion in the composite the fabric reinforcement is self-primed by dipping in a polyethylene priming solution. The composite is derived from pre-formed sheets stacked in different patterns which yield upon compression molding into composite devices with variable thickness and degrees of mechanical properties. The primer may contain one or more additives to impart certain properties to the final composite.

The present application claims the benefit of prior provisional application Ser. No. 61/279,932, filed Oct. 29, 2009.

### FIELD OF THE INVENTION

The invention relates to self-primed fibrous constructs of high strength yarn made of ultra-high molecular weight polyethylene (UHMW-PE) with a lower melting polyethylene coating in self-reinforced composites having UHMW-PE or high-density polyethylene (HDPE) as a matrix and further to crosslinking components of the composite using gas-assisted radiation crosslinking to produce material for use in medical applications, police/military protective equipment and sports equipment.

### BACKGROUND OF THE INVENTION

Most pertinent prior art to the instant invention are U.S. Pat. Nos. 5,824,411 (1998), 5,834,113 (1998) by Shalaby et al., which dealt with composites of UHMW-PE reinforced with UHMW-PE of high strength and modulus fibers. The composites have superior mechanical properties relative to non-filled UHMW-PE, including higher strength, impact strength, increased creep resistance and improved modulus. The composites may be sterilized for biomedical use, using gamma radiation and other techniques. Further, the composites are resistant to the effect of body fluids and have lower creep rates so that they will provide implant life. The composites may be crosslinked by exposure to an acetylene environment. Also, the composites find use in other high strength, high impact applications such as sports equipment.

Other prior are is contained in a series of patents by Klocecek et al., namely, U.S. Pat. Nos. 5,573,824 (1996); 5,879,607 (1999); 6,935,651 (1999); 6,077,381 (2000); and 6,083,583 (2000), which collectively dealt with the same following disclosure: A protective impact resistant material and method, the material comprising a fabric of thermoplastic polymeric fibers having a strength of at least 0.5 GPa and an elastic modulus of at least 25 GPa and a matrix of polymeric material disposed in the interstices between the fibers, the matrix having an elastic modulus in the rant 0.2 to 3×10⁶ psi. The polymeric fibers can be gel spun polyethylene, polypropylene, nylon, polyvinyl alcohol and polyethylene terephthalate. In a second embodiment, the matrix is derived from the fabric. The method of making the material comprises providing a matrix of melted polymeric material transparent to energy of a predetermined type and having a predetermined melting temperature, placing a fabric of polymeric fibers having a melting temperature higher than the melting temperature of the matrix in the matrix, applying a pressure of 1000 to 2000 psi to the fabric disposed in the matrix, then raising the temperature to the melting temperature of the fabric for the minimum time required to cause consolidation of the fabric and the matrix and rapidly cooling the consolidated fabric and matrix to a temperature below the melting temperature of the fabric. In accordance with a second embodiment here is provided a fabric of polymeric fibers as in the first embodiment which is operated upon as in the first embodiment to cause melting of a sufficient portion of the fabric to fill the interstices between the fibers of the fabric and the fabric is then rapidly cooled to a temperature below the melting temperature of the fabric.

However, the prior art was silent on means to maximize the effectiveness of self-reinforcement using high strength UHMW-PE fibers in a chemically identical HDPE or UHMW-PE matrix. This provided an incentive to pursue the study, subject of this invention. Accordingly, this invention deals with the use of a relatively low melting polyethylene primer to provide a low melting interface between the high strength reinforcing UHMW-PE fiber and the continuous phase of the matrix PE or UHMW-PE without compromising the orientation and hence, the strength and modulus of the UHMW-PE fibers.

### SUMMARY OF THE INVENTION

The present invention is directed to a self-primed fabric in a self-reinforced polyethylene composite with a fabric/matrix weight ratio of 13/87 to 43/57, the self-primed fabric comprising ultra-high molecular weight polyethylene fibers, wherein the self-primed fabric is made by the method of dipping the fabric in less than 20 percent solution of low-or high-density polyethylene in xylene at temperatures of 105° C. to 120° C., the fabric is withdrawn from the solution, dried in an air circulating hood and weighed for percent add-on, and wherein the matrix is made of ultra-high molecular weight polyethylene and the fabric is self-primed with less than 20 weight percent of low-or high density polyethylene, and further wherein the fabric is a warp-knitted mesh. Additionally, such self-primed fabric in the self-reinforced polyethylene composite irradiated with about 25 to 60 kGy of high energy radiation in the presence of at least one reactive gas selected from the group consisting of acetylene, butadiene, chlorotrifluoroethylene and vinylidine fluoride.

Another aspect of this invention deals with a self-primed fabric in a self-reinforced polyethylene composite with a fabric/matrix weight ratio of 13/87 to 43/57, the self-primed fabric comprising ultra-high molecular weight polyethylene fibers, wherein the matrix and the fabric are made of high-density polyethylene and gel-spun, ultra-high molecular weight polyethylene fiber, respectively, the fabric is self-primed with less than 20 weight percent of low density polyethylene, wherein said composite is irradiated with less than 60 kGy of high energy radiation in the presence of at least one reactive gas selected from the group consisting of acetylene, butadiene, chlorotrifluoroethylene and vinylidine fluoride. For certain applications, the said composite is irradiated with 30 kGy of high energy radiation in the presence of acetylene gas to produce crosslinked articles for use in one or more application selected from those associated with orthopedic and maxillofacial surgeries, protection against impinging bullets, surfboard components, helmets, shipping containers, and impact resistant sports equipment.

From an application perspective, this invention deals with a self-primed fabric in a self-reinforced polyethylene composite with a fabric/matrix weight ratio of 13/87 to 43/57, the self-primed fabric comprising ultra-high molecular weight polyethylene fibers, wherein the matrix and the fabric are made of high-density polyethylene and gel-spun, ultra-high molecular weight polyethylene fiber, respectively, the fabric is self-primed with less than 20 weight percent of low density polyethylene, wherein said composite is irradiated with 25 to 40 kGy of high energy radiation in the presence of acetylene gas to produce crosslinked materials in at least one form selected from the group consisting of bullet-proof vests, high impact components of car seats, helmets, impact resistant sports equipment, explosion resistant shipping containers and surfboard components.

A significant aspect of the invention deals with a self-primed fabric in a self-reinforced polyethylene composite with a fabric/matrix weight ratio of 13/87 to 43/57, the self-primed fabric comprising ultra-high molecular weight polyethylene fibers, wherein the self-primed fabric is made by the method of dipping the fabric in less than 20 percent solution of low-or high-density polyethylene in xylene at temperatures of 105° C. to 120° C., the fabric is withdrawn from the solution, dried in an air circulating hood and weighed for percent add-on and wherein the priming solution contains at least one additive selected from the group consisting of antimicrobial agents, anti-inflammatory agents, organic dyes and cell growth promoters.

### DETAILED DESCRIPTION OF PREFERRED EMBODIMENTS

In one aspect the present invention is directed to a significant improvement over the prior art on the preparation of fiber self-reinforced UHMW-PE wherein both the fibers and matrix are made of UHMW-PE with up to 12 weight percent of the fiber reinforcement and an intimate interface between the fibers and matrix to maximize the effectiveness of the reinforcement. Specifically, the improvement over the prior art as described in the instant invention entails the use of a thin layer of low-melting, high-density and/or low-density polyethylene to abridge the UHMW-PE fibers and matrix, thus allowing the use of more than 12 weight percent of the reinforcing fiber leading to significant increase in the maximum strength, creep resistance, toughness, and other related properties. The low-melting abridging component of the instant invention is, in effect, a primer applied from a hot solution of a low-melting polyethylene from its solution in a solvent (e.g., xylene) that wets and can dissolve the uppermost surface layer of the UHMW-PE fibers. Drying the primed, or better denoted the self-primed, fibers that constitute a warp-knitted mesh yields a self-primed fabric which can be easily incorporated into a self-reinforced composite of UHMW-PE (or HDPE) matrix with the self-primed fabric or mesh. Constructing or assembling the later in such a manner (1) provides a facile method for assembly of the composite; (2) allows the use of minimum temperature by virtue of the low-melting primer, intimately abridging the UHMW-PE (or HDPE) matrix with the UHMW-PE fibers (e.g., in the form of a mesh) without compromising the high degree of fiber orientation, and hence retaining the strength of the reinforcing phase—additionally, the application of a low-melting primer, which can be applied from a solution at 105 to 120° C. permits the use of additives, including temperature sensitive additives, which can impart desirable properties to the composites and this entails the use of (a) organic dyes to color or tint the composite; (b) antimicrobial agents to provide a long-term sustained release of these agents and hence, prolonged antimicrobial activity; and (c) certain other agents including antioxidants, anti-inflammatory drugs and cell growth promoters; (3) makes it possible to stack several layers of the preformed UHMW-PE (or HDPE) sheets and self-primed reinforcing meshes in more than one pattern, thus yielding composites with variable thickness and degrees of anisotropy between the two major surfaces of the composites—this, in part, provides a high degree of freedom in designing the composite for use in medical and non-medical products with variable load-bearing and mechanical property requirements across the surface and thickness of the different composite devices; and (4) allows the incorporation of more than 12 weight percent of the mesh in the composite and hence maximizing the properties of the reinforced construct.

Further illustrations of the present invention are provided by the following examples:

### EXAMPLE 1

### Preparation of a Typical Warp-knitted Mesh

For mesh preparation, a multifilament, 650 denier yarn made of UHMW-PE comprising 120 filaments was used. The single filament diameter was 30 μm. The yarn exhibited a tensile strength of 2 GPa. The yarn was twisted to yield one twist per inch prior to warping and knitting, using a GE 203A warper and TR-6-E18 Rachel 6-bar knitting machine, respectively. The resulting warp-knitted mesh has 21 courses per inch and fabric width of 117.2 mm. The knitted fabric was cut into 12, five-inch pieces. To remove any fiber finishing additives, the meshes were sonicated in isopropyl alcohol for 5 minutes and dried prior to self-priming.

### EXAMPLE 2

### Preparation of Self-primed Knitted Fabric using Mesh from Example 1

For self-priming, a typical warp-knitted mesh from Example 1 was dip-coated in a 6 percent solution of low density polyethylene in xylene at 110° C. for about 15 seconds. The mesh was removed and allowed to dry in a laminar flow hood until a constant weight was realized

### EXAMPLE 3

### Preparation of a Typical UHMW-PE Sheet

To prepare the UHMW-PE sheet components for use in assembling the self-reinforced composites, the polymer powder was compression-molded in a Carver Laboratory Press using a stainless steel mold. Using a temperature of 180° C. and pressure of 30,000 lbs. for 30 minutes allowed the conversion of the UHMW-PE powder into uniform sheets having a thickness of 1.3 mm.

### EXAMPLE 4

### Preparation of Typical Self-reinforced Composite with Variable Fractions and Locations of the Self-primed Mesh in the Matrix

The first step toward assembling a self-primed mesh from Example 2 into a fiber self-reinforced mesh entails stacking the UHMW-PE sheets from Example 3 and the self-primed meshes from Example 1 in two patterns, I to IV. In Pattern I, three sheets were stacked in an alternating manner with two meshes and three sheets. In Pattern II, two meshes were stacked in an alternating manner with three sheets topped with two additional sheets. And a Carver Laboratory Press and a special mold to keep the mesh under tension (or strained) were used to form self-reinforced composite sheets having variable thickness according to the following scheme:

Step 1: Stacked components were heated at 140° C. under 15,000 lbs. pressure for 30 minutes.

Step 2: The pressure on the heated stacks was increased to 30,000 lbs. and the temperature was maintained at 140° C. for 60 minutes.

Step 3: The stacked components were allowed to cool to 110° C. and annealed under 30,000 lbs. of pressure for 60 minutes.

The preparation and properties of the composites based on typical primed meshes using Patterns I and II are summarized in Table I.

TABLE I
Comparative Properties of Typical N-I and N-II Patterns,
UHMW-PE Composites Using Unprimed and Self-primed Meshes^{a}

| | Mesh | | | Mechanical Properties^{b} | | |
|---|---|---|---|---|---|---|
| Com- | Orien- | | | Thick- | Max. | |
| posite | tation^{c} | | Self- | ness | Strength | Modulus |
| No. | (Degree) | Pattern | Priming | mm | MPa | MPa |
| U-P | 0-0 | I | No | 3.7 | 37 | 652 |
| P-1 | 0-0 | I | Yes^{d} | 3.9 | 50 | 718 |
| P-2 | 0-0 | II | Yes^{d} | 4.5 | 54 | 651 |

^{a}The mesh was strained during composite assembling and compression molding.
^{b}Using the 3-point bend method.
^{c}Zero (0) indicates the wale direction of the mesh.
^{d}Percent add-on of primer was about 9% based on mesh weight.

### EXAMPLE 5

### Preparation of Typical Self-reinforced Composite with Unprimed Mesh

A self-reinforced mesh based on unprimed mesh from Example 1 and a UHMW-PE sheet from Example 3 were prepared following the same procedure used in Examples 4-6 for the self-primed meshes having stacking Pattern I. Preparation and properties of composites based on typical unprimed meshes using Pattern I are summarized in Table I.

### EXAMPLE 6

### Preparation of Typical Self-reinforced Composites of Self-primed Mesh without Straining the Mesh

Two stacking patterns, III and IV, were used to prepare the composites without straining the meshes. In Pattern III, the compositions were stacked as follows: 3 sheets+mesh+sheet+mesh+sheet. In Pattern IV, the components were stacked as follows: 3 sheets+mesh+2 sheets+mesh+sheet. The molding scheme entailed the use of preformed plates and a two-stage cycle: First Stage, 145° C., 15,000 lbs. for 30 minutes; Second Stage: 110° C., 15,000 lbs. for 30 minutes. Preparation and properties of the compositions are summarized in Table II.

TABLE II
Comparative Properties of Typical N-III and N-IV Pattern
UHMW-PE Composites Using Self-primed Meshes^{a}

| | Mesh | | | Mechanical Properties^{b} | | |
|---|---|---|---|---|---|---|
| Com- | Orien- | | | Thick- | Max. | |
| posite | tation^{c} | | Self- | ness | Strength | Modulus |
| No. | (Degree) | Pattern | Priming | mm | MPa | MPa |
| P-3 | 0-0 | III | Yes^{d} | 5.8 | 82 | 446 |
| P-4 | 0-0 | IV | Yes^{d} | 6.8 | 60 | 309 |

^{a}Meshes were not strained during composite assembling and compression molding.
^{b}Using a 3-point bend method.
^{c}Zero (0) indicates the wale direction of the mesh.
^{d}Percent add-on of the primer was about 9% based on mesh weight.

### EXAMPLE 7

### A Typical Gas-assisted Crosslinking of Meshes from Examples 4-6

To maximize crosslinking of the chains of all components of the composite and to allow for some bridging between the primed mesh and sheet, the self-reinforced polyethylene composites of Examples 4 to 6 were irradiated with 30 kGy of gamma radiation in the presence of an acetylene gas. The effects of the gas-assisted bridging of the different components of the composites and the chain crosslinking the individual components were assessed in terms of (1) extent of swelling in xylene at 110° C., and (2) effect on modulus and breaking strength.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims. Moreover, Applicant hereby discloses all subranges of all ranges disclosed herein. These subranges are also useful in carrying out the present invention.

What is claimed is:

1. A fabric/matrix polyethylene composite comprising a polyethylene matrix, and a reinforcing polyethylene fabric matrix, the matrix comprising gel-spun ultra-high molecular weight polyethylene fibers and a polyethylene coating, the fabric/matrix weight ratio comprising from about 13/87 to about 43/57.

2. A polyethylene composite as in claim 1 wherein the coating is applied to the fabric by the method of dipping the fabric in a priming solution of less than 20 percent of low-or high-density polyethylene in xylene at temperatures of 105° C. to 120° C.

3. A polyethylene composite as in claim 1 wherein the matrix is made of ultra-high molecular weight polyethylene and the coating comprises low-or high density polyethylene.

4. A polyethylene composite as in claim 3 wherein the fabric is a warp-knitted mesh.

5. A polyethylene composite as in claim 4 irradiated with about 25 to 60 kGy of high energy radiation in the presence of at least one reactive gas selected from the group consisting of acetylene, butadiene, chlorotrifluoroethylene and vinylidine fluoride.

6. A polyethylene composite as in claim 1 wherein the matrix comprises high-density polyethylene, the fabric comprises gel-spun, ultra-high molecular weight polyethylene fiber, and the fabric coating comprises low density polyethylene.

7. A polyethylene composite as in claim 6 irradiated with less than 60 kGy of high energy radiation in the presence of at least one reactive gas selected from the group consisting of acetylene, butadiene, chlorotrifluoroethylene and vinylidine fluoride.

8. A polyethylene composite as in claim 5 irradiated with 30 kGy of high energy radiation in the presence of acetylene gas to produce crosslinked articles for use in one or more application selected from those associated with orthopedic and maxillofacial surgeries, protection against impinging bullets, surfboard components, shipping containers, helmets and impact resistant sports equipment.

9. A polyethylene composite as in claim 6 irradiated with 25 to 40 kGy of high energy radiation in the presence of acetylene gas to produce crosslinked materials in at least one form selected from the group consisting of bullet-proof vests, high impact components of car seats, helmets, impact resistant sports equipment, explosion resistant shipping containers and surfboard components.

10. A polyethylene composite as in claim 2 wherein the priming solution contains at least one additive selected from the group consisting of antimicrobial agents, anti-inflammatory agents, organic dyes and cell growth promoters.
